(19) United States
(12) Patent Application Publication
(10) Pub. No.: US 2026/0325394 A1
(43) Pub. Date: Oct. 22, 2026

(54) COMPRESSION THERAPY GARMENT WITH INTEGRATED PHYSIOLOGICAL MONITORING AND ADAPTIVE CONTROL

(71) Applicant: Farzad Sadeghi TOHIDI, Kennesaw, GA (US)

(72) Inventor: Farzad Sadeghi TOHIDI, Kennesaw, GA (US)

(73) Assignee: ModuMed, Inc., Kennesaw, GA (US)

(21) Appl. No.: 19/468,861

(22) Filed: Feb. 3, 2026

Related U.S. Application Data
(60) Provisional application No. 63/779,106, filed on Mar. 27, 2025.

(51) Int. Cl. A61H 9/00

(52) U.S. Cl. CPC A61H 9/0092; A61H 2201/1621; A61H 2201/1642; A61H 2230/305

(57) ABSTRACT

A device may include a sleeve arranged to be disposed at least partially around a human limb and/or an abdominal region. The device may include a plurality of flexible air chambers disposed along at least a portion of the length of the sleeve, wherein each of the plurality of air chambers may be arranged to be individually inflated and deflated. The device may include a controller arranged to sequentially inflate a first chamber of the plurality of air chambers then a second chamber of the plurality of air chambers to improve blood flow up the leg.

### CROSS-REFERENCE TO RELATED APPLICATIONS

This application claims priority to U.S. provisional patent application Ser. No. 63/779,106, for “MODULAR WEARABLE COMPRESSION THERAPY GARMENTS FOR MEDICAL AND ATHLETIC APPLICATIONS” filed on Mar. 27, 2025, which is hereby incorporated by reference in entirety for all purposes.

### FIELD

The present disclosure relates generally to wearable therapeutic devices. More particularly, the disclosure relates to compression garments configured to improve blood circulation through programmable, sequential pneumatic compression, integrated physiological monitoring, and adaptive control systems.

### BACKGROUND

Conventional compression garments suffer from several limitations. The compression rating, measured in millimeters of mercury, is predetermined during manufacturing and cannot be adjusted once the garment is donned. The pressure remains constant regardless of changes in limb circumference due to swelling, activity level, or postural shifts. This fixed-pressure approach fails to account for the dynamic nature of circulatory physiology and may result in subtherapeutic compression or excessive constriction that causes discomfort.

Another limitation of existing compression garments is the lack of regional customization. Static compression socks apply uniform pressure along the entire length of the leg, without regard to anatomical variations or the specific circulatory needs of different leg regions. This often results in excessive tightness at garment edges, particularly behind the knee, causing discomfort commonly referred to as sock bite. Patients frequently report pinching, restricted movement, and skin irritation, which significantly limits compliance and the duration for which these garments can be tolerated. Yet further, the fixed compression in traditional compression socks or garments makes it particularly difficult for patients to put them on and take them off.

Perhaps most significantly, conventional compression garments operate entirely passively. They lack any capability to actively respond to a patient's real-time circulatory condition. There is no sensor feedback, no synchronization with cardiovascular activity such as heart rate, and no intelligent control of pressure timing or localization. These garments simply compress the leg to reduce vein diameter and discourage blood pooling, but they do not facilitate active upward blood movement through coordinated, pulsatile pressure patterns.

There remains an unmet need for a wearable, intelligent compression system that provides dynamic, adaptive pressure tailored to individual physiological responses, that synchronizes with cardiovascular rhythms, that responds to postural changes, and that can be comfortably worn during daily activities to improve both therapeutic efficacy and patient compliance.

### BRIEF SUMMARY

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

In some embodiments, a device may be arranged to be worn on a human leg. The device may include a first chamber arranged to at least partially encircle the leg. The device may include a second chamber arranged to at least partially encircle the leg and arranged to be positioned at a location above the first chamber on the leg. The device may include a controller configured to at least partially inflate the first and the second chambers.

In some embodiments, the controller may be further configured to sequentially inflate the first chamber before the second chamber. In various embodiments, the controller may be further configured to sequentially deflate the first chamber before the second chamber. In some embodiments, the controller may be further configured to perform the sequential inflation in rhythm with a pulse of the human. In various embodiments, the controller may be further configured to inflate the first chamber to a first pressure and inflate the second chamber to a second pressure, wherein the second pressure may be less than the first pressure.

In some embodiments, the controller may be further configured to detect a recumbent position of the human and in response, at least partially deflate the first and the second chambers. In various embodiments, the device may further include a cooling system arranged to cool at least a portion of the leg. In some embodiments, the controller may be further configured to modulate the at least partial inflation of the first and the second chambers based on a circumference of the leg. In various embodiments, the controller may be further configured to detect a blood pressure of the human and in response, modulate the at least partial inflation of the first and the second chambers.

In some embodiments, a device may be arranged to at least partially receive a human limb and/or a portion of an abdomen. The device may include a sleeve having a length extending between a first end and a second end and arranged to receive a portion of the limb such that the first end may be proximate a base of the limb and the second end may be proximate a distal end of the limb. The sleeve may include a plurality of flexible air chambers disposed along at least a portion of the length of the sleeve, wherein each of the plurality of air chambers may be arranged to be individually inflated and deflated. The device may include a controller arranged to at least partially inflate each of the plurality of air chambers.

In some embodiments, the controller may be arranged to inflate a first chamber of the plurality of chambers to a first pressure and to inflate a second chamber of the plurality of chambers to a second pressure, wherein the first pressure may be greater than the second pressure. In various embodiments, the controller may be arranged to simultaneously inflate the first chamber and the second chamber. In some embodiments, the controller may be arranged to sequentially inflate the first chamber then the second chamber. In various embodiments, the controller may be further configured to perform the sequential inflation in rhythm with a pulse of the human. In some embodiments, the controller may be configured to detect a recumbent position of the human and in response, at least partially deflate at least one of the plurality of air chambers.

In some embodiments, a method of operating a device may include disposing a sleeve at least partially around a human limb, wherein the sleeve may include a plurality of flexible air chambers disposed along at least a portion of a length of the sleeve and wherein each of the plurality of air chambers may be arranged to be individually inflated and deflated. The method may include at least partially inflating the plurality of air chambers. In some embodiments, the plurality of air chambers may be simultaneously at least partially inflated. In various embodiments, the plurality of air chambers may be sequentially at least partially inflated. In some embodiments, the controller may be further configured to perform the sequential inflation and the sequential deflation in rhythm with a pulse detected in the human limb. In various embodiments, the controller may be configured to detect a recumbent position of the human limb and in response, at least partially deflate at least one of the plurality of air chambers

### BRIEF DESCRIPTION OF THE DRAWINGS

Embodiments are illustrated by way of example and not limitation in the figures of the accompanying drawings, in which like references indicate similar elements.

FIG. 1 illustrates a front view of a wearable compression device with multiple inflatable chambers arranged along bilateral leg sleeves, according to some embodiments of the disclosure.

FIG. 2 depicts a wearable compression device with upper and lower sleeves incorporating inflatable chambers, sensors, and cooling components, according to some embodiments of the disclosure.

FIG. 3 shows a wearable compression device on a human body with various physiological sensors and monitoring components, according to some embodiments of the disclosure.

FIG. 4 presents a block diagram of an electronic system architecture including processor, memory modules, and peripheral interfaces that can be employed with the compression devices disclosed herein.

FIG. 5 illustrates a system diagram showing interconnections between sensors, control unit, cooling system, pumps, and mobile application interface that can be employed with the compression devices disclosed herein.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein may relate generally to wearable therapeutic devices. More specifically, techniques disclosed herein may relate to compression garment systems including multiple inflatable chambers that may provide sequential pneumatic compression with both high therapeutic efficacy and enhanced user comfort. Various embodiments may be described herein, including methods, processes, systems, devices, and the like.

In order to better appreciate the features and aspects of the present disclosure, further context for the disclosure may be provided in the following section by discussing one particular implementation of a wearable compression garment system according to embodiments of the disclosure. These embodiments may be for explanatory purposes only and other embodiments may be employed in other therapeutic devices. For example, embodiments of the disclosure may be used with any device that provides circulatory support or hemodynamic assistance.

The present disclosure relates to a wearable compression garment system designed to improve blood circulation in individuals experiencing circulatory challenges. The system may be particularly beneficial for patients with autonomic nervous system disorders such as Postural Orthostatic Tachycardia Syndrome (POTS), neurogenic orthostatic hypotension (NOH), venous insufficiency or other conditions characterized by impaired venous return. The garment may provide dynamic, adaptive compression therapy that responds to the wearer's physiological state in real time. This system could also be advantageous for pilots who experience circulatory challenges due to high G-forces during maneuvers, such as rapid takeoff or aerial combat. By dynamically adapting compression in real time, it may help maintain proper blood flow under extreme conditions.

The compression garment may be embodied as a pair of pneumatic leggings or pants that may extend from the ankle region to the upper thigh or waist and may include an abdominal compression region. The garment may incorporate multiple inflatable air chambers arranged sequentially along the length of each leg and/or the abdominal region. These chambers may be configured to inflate and deflate in a coordinated pattern, creating a wave of pressure that progresses from the distal portions of the legs toward the proximal regions and/or the abdomen. This sequential compression may facilitate upward blood flow by mechanically assisting venous return, thereby reducing venous pooling in the lower extremities.

The system may include integrated physiological sensors that continuously monitor various parameters such as body position, heart rate, blood pressure, blood flow velocity, tissue oxygenation, and body position. The data collected by these sensors may be processed by a control unit that adjusts compression parameters dynamically. The control unit may synchronize compression cycles with the user's cardiac rhythm, modify pressure levels based on detected posture changes, and activate cooling elements when beneficial for circulatory enhancement. Further, the control unit may disengage the compression cycles when it senses that the user is in a recumbent position and there is no need to operate the device. This adaptive approach may allow the garment to provide personalized therapy that evolves with the user's changing physiological needs throughout the day.

The garment may be constructed from breathable, antimicrobial fabric materials that permit extended wear without causing skin irritation or discomfort. Electronic components may be removable to facilitate washing and maintenance of the garment. The system may communicate wirelessly with a companion mobile application that provides users with real-time feedback on their physiological status and control over the therapy settings. Healthcare providers may access patient data remotely through secure cloud-based platforms, enabling them to monitor treatment adherence and adjust therapy protocols as needed. This comprehensive approach may bridge the gap between prescribed medical therapy and practical daily use, potentially improving patient outcomes and quality of life.

Beyond medical applications, the system can be adapted to support recovery and performance enhancement in athletes, mitigate fatigue and swelling during long travel, and assist in post-operative recovery by promoting healthy circulation. Furthermore, it can be utilized in high-G environments such as aviation or space travel, helping pilots and astronauts maintain stable blood flow during extreme conditions. This versatile and intelligent garment thus bridges the gap not only in clinical therapy but also in occupational, athletic, and aerospace scenarios, offering a wide range of potential uses beyond traditional healthcare.

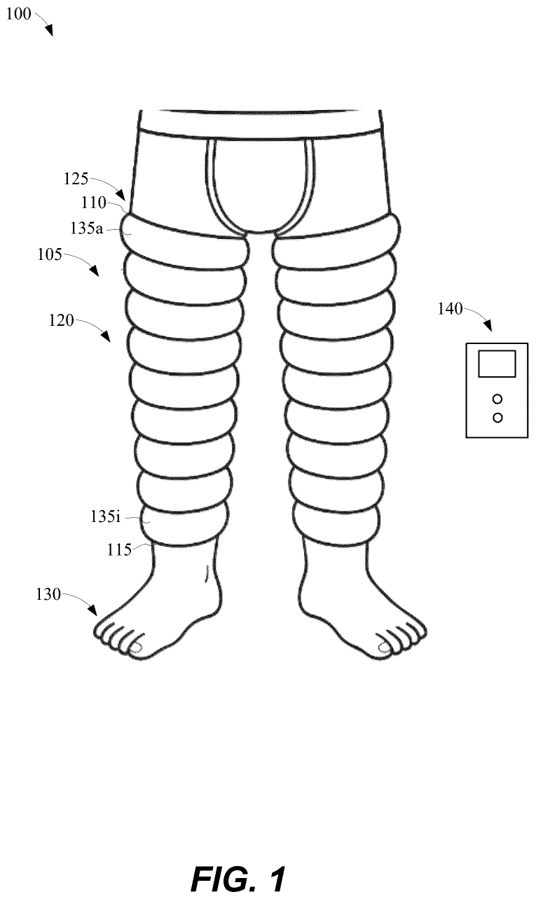

FIG. 1 illustrates a wearable compression device arranged to be worn on human legs, according to embodiments of the disclosure. As shown in FIG. 1, the device 100 may comprise a pair of sleeves 105, each sleeve extending between a first end 110 and a second end 115. Each sleeve 105 may be arranged to receive a portion of a human limb 120. The first end 110 may be positioned proximate a base of the limb 125, while the second end 115 may be positioned proximate a distal end of the limb 130. The sleeve 105 may include a plurality of flexible air chambers 135 disposed along at least a portion of the length of the sleeve. A controller 140 may be arranged to at least partially inflate each of the plurality of air chambers 135.

The device 100 may be configured to provide therapeutic compression to the lower extremities of a user. More specifically, the air chambers 135 are designed to inflate and deflate in a controlled, sequential manner starting from the lower leg and moving upward, mimicking the natural action that helps push blood back to the heart. In some embodiments the chambers 135 may not physically overlap each other and instead a control algorithm may be configured to generate an effective overlapping compression profile through coordinated inflation timing and pressure modulation. As one chamber inflates and the next chamber begins to inflate, the pressure shifts gradually upward, creating a gentle wave of compression. This approach ensures that there are no sudden or uniform squeezes, rather, it delivers a dynamic and continuous massage-like sensation that promotes better blood flow. In some embodiments the rhythmic inflation can be synchronized with the heartbeat of the user providing timed assistance to the heart, as explained in more detail below.

In some embodiments the inflation sequence may be modified based on chamber volume and/or the fill rate of the chambers. For example, if chamber 135a is larger than, or takes more time to fill than, chamber 135b and it is desired that chamber 135b reaches its target pressure right before 135a, the controller may initiate the filling of chamber 135a before 135b. In some embodiments a learning control algorithm (e.g., machine learning, artificial intelligence, etc.) may monitor target pressures and other parameters and learn to initiate the filling of the chambers so the target pressures are reached at the appropriate (programed) times.

The sleeves 105 may be constructed from materials suitable for use as air chambers (described in more detail below) and materials suitable to form the structure of the device, such as a textile fabric. The textile fabric may be breathable to allow air circulation and moisture evaporation during extended wear. The fabric may incorporate antimicrobial properties to inhibit bacterial growth and/or may be hypoallergenic to minimize skin irritation. The garment structure may be configured to conform to the contours of the leg while maintaining sufficient flexibility for comfortable movement.

Each sleeve 105 may extend from the upper thigh region to the ankle region. The first end 110 may be positioned at or near the inguinal crease or upper thigh. The second end 115 may be positioned at or near the ankle or lower calf. The sleeve 105 may be designed to cover substantially the entire length of the leg between these two points. The sleeve 105 may be secured to the leg through various fastening mechanisms including but not limited to, hook-and-loop fasteners, elastic bands, suspenders, and/or adjustable straps may be provided to customize the fit to different leg circumferences.

The plurality of flexible air chambers 135 may be embedded within the garment structure of the sleeve 105. Each air chamber may be constructed from an airtight, flexible material. Thermoplastic polyurethane, silicone or other suitable polymer material may be used for the chamber walls. The chamber material may have a thickness ranging from 0.1 millimeters to 1.0 millimeters. The chambers may be arranged in a sequential manner along the length of the sleeve 105. A first chamber 135a may be positioned near the first end 110. Additional chambers may be positioned progressively toward the second end 115. A final chamber 135i may be positioned near the second end 115. The number of chambers may range from 4 to 20 per sleeve, between 6 to 15 or between 8 to 12.

In some embodiments the chambers 135 may be arranged to at least partially encircle the leg. Each chamber may wrap around a portion of the leg circumference. Some chambers may encircle the leg completely. Other chamber configurations may not encircle the leg and may cover only specific anatomical regions. In some embodiments chambers may be positioned over specific veinous regions. In various embodiments chambers may be positioned over areas with prominent superficial veins, over the popliteal region behind the knee or over the medial thigh region where the great saphenous vein is located.

In some embodiments adjacent chambers may be positioned with overlapping coverage zones. The overlapping arrangement may ensure continuous pressure application without gaps. The overlap between adjacent chambers may range from 10 percent to 40 percent of chamber length. The overlapping configuration may be achieved through physical positioning of chamber boundaries. The chambers may be sewn or bonded to the garment fabric with offset attachment points. The overlapping effect may also be created through a control algorithm to generate an effective overlapping compression profile via the coordinated timing of inflation sequences. In some embodiments one chamber may begin inflating before an adjacent chamber fully deflates.

Each air chamber 135 may have an internal volume when fully inflated that may range from 50 milliliters or less to 200 milliliters or more per chamber. Larger chambers positioned on the thigh may have volumes toward the upper end of this range. Smaller chambers positioned on the calf or ankle may have volumes toward the lower end. The chambers may be designed to expand when inflated and the expansion may be controlled by internal baffles or reinforcement structures within each chamber. The baffles may prevent excessive ballooning and ensure uniform pressure distribution across the chamber surface.

The user may experience rhythmic pressure sensations as the chambers 135 inflate and deflate sequentially. The pressure may begin at the ankles and progress upward. The user may feel a gentle squeezing action that mimics natural muscle contractions. The compression may promote venous return and reduce blood pooling in the lower extremities.

In FIG. 1, the controller 140 is shown separate from the device worn by the user, however in some embodiments the entire controller or a portion thereof may be integrated into the device worn by the user. The controller 140 may be configured to control inflation and deflation of the plurality of air chambers 135. The controller 140 may execute a sequential compression protocol that may begin with inflation of the most distal chamber near the ankle at the second end 115. Subsequent chambers may be inflated in progression toward the first end 110. The inflation sequence may create a wave of pressure traveling up the leg 120. The pressure wave may facilitate upward movement of venous blood toward the heart.

The controller 140 may determine target pressures for each chamber. In some embodiments the target pressure within each chamber may be substantially equal. In other embodiments the target pressures may range from 20 millimeters of mercury to 200 millimeters of mercury. In various embodiments some chambers (e.g., distal chambers near second end 115) may be inflated to higher pressures and some chambers (e.g., proximal chambers near first end 110) may be inflated to lower pressures. A graduated pressure profile may be created with pressures decreasing from ankle to thigh. An example gradient may provide 50 millimeters of mercury at the ankle, 40 millimeters of mercury at the calf, 30 millimeters of mercury at the knee, and 25 millimeters of mercury at the thigh.

The controller 140 may regulate the duration of inflation for each chamber. Each chamber may be maintained at target pressure for 0.1 seconds to 10 seconds or more. The controller 140 may initiate deflation after the specified duration. Deflation may occur through opening of exhaust valves and/or the application of a vacuum for rapid deflation. Deflation time may range from 0.1 seconds to 2 seconds or more per chamber.

The controller 140 may implement a rest period between compression cycles. The rest period may allow venous refilling before the next compression cycle begins. Rest periods may range from 1 second to 30 seconds or more. The controller 140 may repeat the compression cycle continuously during a therapy session. Alternatively, the controller 140 may execute a specified number of cycles before pausing.

The user may adjust settings of the device 100 through a user interface which may include the controller 140, a separate electronic device (e.g., smartphone, smartwatch, computing device, etc.) The controller 140 may include physical buttons for basic adjustments. A power button may turn the device on or off. Intensity buttons may increase or decrease compression pressure. Mode buttons may select different compression patterns. The user may access more detailed settings through a mobile application. The mobile application may communicate wirelessly with the controller 140.

The device 100 may include a pneumatic subsystem for delivering compressed air to the chambers. The pneumatic subsystem may comprise at least one air pump and/or compressed air source of any suitable type. The pneumatic subsystem may include a plurality of electronically controlled valves. Each valve may be associated with a specific air chamber. The valves may be solenoid valves, piezoelectric valves or any other suitable type of valve. Pneumatic tubing may connect the valves to individual chambers and/or to the air source.

The pneumatic subsystem may include one or more pressure sensors for monitoring chamber pressures. In some embodiments each chamber 135 may have an associated pressure sensor. Alternatively, a multiplexed sensor configuration may be employed. The pressure sensors may be piezoresistive, capacitive or other suitable type of sensor. The sensors may provide real-time feedback to the controller 140 which may implement closed-loop pressure control based on sensor readings.

The controller may be able to sense a size of the user's leg by monitoring the pressure within one or more of the chambers and adjust therapy based on a size of the user's leg. More particularly, the controller may be configured to modulate the at least partial inflation of the first and the second chambers based on a circumference of the leg. In some embodiments an initial calibration routine may be performed where the controller inflates each chamber to a predetermined pressure or inflates each chamber using a predetermined volume of air.

The device 100 may include a power supply for energizing the controller 140 and pneumatic subsystem. The power supply may comprise a rechargeable battery including but not limited to a lithium-ion or lithium-polymer type. In some embodiments the controller 140 may be a dedicated controller for the device 100, or the controller may be an application program operating on a computing device (e.g., smartphone, laptop, mobile computing device, and the like).

The device 100 may be operated by a user for managing circulatory conditions. A user may don the sleeves 105 by stepping into them and pulling them up the legs. The user may secure any fasteners to ensure proper fit. The user may activate the controller 140 by pressing a power button. The controller 140 may initiate a self-check sequence. The controller 140 may verify sensor functionality and battery status. Upon successful initialization, the controller 140 may begin executing the compression protocol.

The device 100 may be used during various activities. For example, the user may wear the device while sitting at a desk, walking, laying down, etc. The device may identify the activity via internal sensors and/or external sensors (e.g., smartphone, smartwatch, etc.) and provide the appropriate therapy associated with the activity. For example, the device may counteract orthostatic blood pooling when the user is upright.

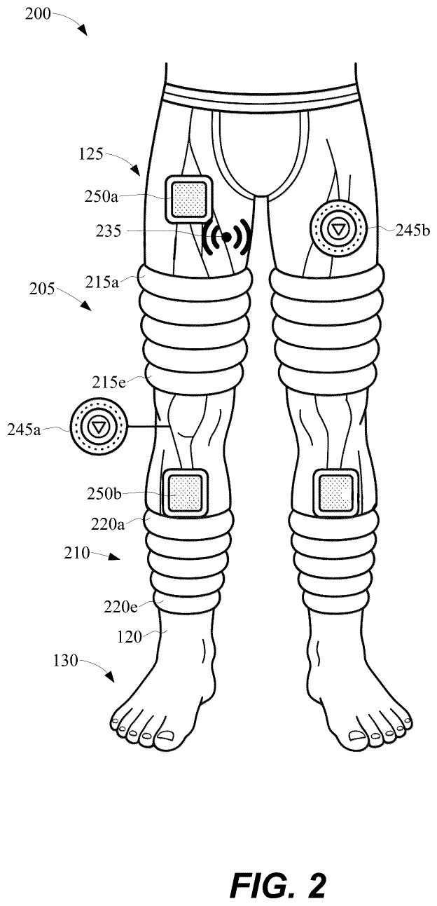

FIG. 2 illustrates a wearable compression device 200, according to embodiments of the disclosure. Compression device 200 may be or may include any of the components, features, or characteristics of any of the compression devices previously described, and any features of compression device 200 may be included in compression devices as previously discussed. As shown in FIG. 2, the device 200 may be similar to compression device 100, however each sleeve of compression device 200 may be separated into two regions and the device may include additional sensors and components.

Device 200 may include an upper sleeve 205 and a lower sleeve 210 for each human limb 120, 125. The upper sleeve 205 may extend from the base of the limb 125 at the upper thigh to a region above the knee. The lower sleeve 210 may extend from a region below the knee to the distal end of the limb 130 near the ankle. The separation into upper and lower sleeves may provide improved fit and flexibility around the knee joint.

The upper sleeve 205 may include a plurality of flexible upper sleeve air chambers 215. In some embodiments the chambers 215 may be arranged sequentially along the length of the upper sleeve 205. An uppermost chamber 215a may be positioned near the base of the limb 125. Additional chambers may be positioned progressively downward. A lowermost chamber 215e of the upper sleeve 205 may be positioned near the knee region. The number of chambers in the upper sleeve 205 may range from 1 to 10, from 2 to 8 or from 3 to 6.

The lower sleeve 210 may include a plurality of lower sleeve flexible air chambers 220. The chambers 220 may be arranged sequentially along the length of the lower sleeve 210. An uppermost chamber 220a may be positioned near the knee region. Additional chambers may be positioned progressively downward. A lowermost chamber 220e of the lower sleeve 210 may be positioned near the ankle. The number of chambers in the lower sleeve 210 may range from 1 to 10, from 2 to 8 or from 3 to 6.

The device 200 may include one or more physiological sensors for monitoring user parameters. In some embodiments a heart rate sensor 235 may be integrated into the garment and may be positioned on the upper thigh region. The heart rate sensor 235 may employ photoplethysmography technology. Light-emitting diodes may emit light at specific wavelengths and a photodetector may measure reflected light intensity. Changes in blood volume may cause variations in light absorption which may be used to determine heart rate. The sensor may provide real-time heart rate data to the controller 140 (see FIG. 1).

The controller 140 may be configured to receive data from the heart rate sensor 235 and execute algorithms to process the sensor data. In some embodiments the controller 140 may calculate instantaneous heart rate from the sensor signal and/or may determine the timing of individual heartbeats. In various embodiments the controller 140 may identify the occurrence of each R-wave in the cardiac cycle and may calculate the duration of each cardiac cycle. The controller 140 may further determine the timing of diastole within each cycle.

In some embodiments the controller 140 may synchronize compression cycles with the user's cardiac rhythm. More specifically, the controller 140 may initiate inflation of chambers at specific points in the cardiac cycle. In some embodiments compression may be timed to occur during diastole which is the period when the heart is filling with blood. Applying compression during diastole may enhance venous return without impeding arterial inflow. The controller 140 may calculate the appropriate delay after R-wave detection to target mid-to-late diastole. The delay may range from less than 0.2 seconds to more than 0.4 seconds depending on heart rate.

The controller 140 may adjust compression timing dynamically as the user's heart rate changes. For example, if the user's heart rate increases, the controller 140 may shorten the delay to maintain synchronization with the faster cardiac cycle. If the heart rate decreases, the controller 140 may lengthen the delay accordingly. The controller 140 may continuously monitor heart rate and update synchronization parameters in real-time. This adaptive synchronization may optimize the hemodynamic benefit of compression therapy.

The device 200 may include position sensors 245a and 245b for detecting user posture and orientation. The position sensors may comprise inertial measurement units and may include a three-axis accelerometer and/or a three-axis gyroscope. The accelerometer may measure gravitational acceleration in three orthogonal directions and the gyroscope may measure angular velocity in three orthogonal directions.

In some embodiments the first position sensor 245a may be positioned on the upper thigh region and the second position sensor 245b may be positioned on the lower leg region, however any suitable number of sensors and placement of sensors can be used. The placement of sensors at two locations may allow for detection of leg orientation and joint angles. The controller 140 may receive data from the position sensors 245a, 245b and may process the sensor data to determine body posture. The controller 140 may employ sensor fusion algorithms, machine learning, complementary filters and/or Kalman filters. In some embodiments the controller 140 may calculate orientation quaternions and/or Euler angles.

The controller 140 may classify the user's posture based on sensor data. For example, a lying down posture may be detected when the trunk orientation is near horizontal and/or the pitch angle may be less than 30 degrees from horizontal. A sitting posture may be detected when the trunk is upright but the thighs are approximately horizontal and/or the pitch angle of the trunk may be 60 degrees to 90 degrees from horizontal and/or the thigh orientation may be approximately 90 degrees from the trunk orientation. A standing posture may be detected when both trunk and legs are near vertical and/or the pitch angle may be greater than 80 degrees from horizontal.

The controller 140 may detect postural transitions. A transition from lying to sitting may be identified by a change in trunk orientation from horizontal to upright. A transition from sitting to standing may be identified by a change in thigh orientation from horizontal to vertical. The controller 140 may detect the rate of postural change. Rapid changes may indicate active transitions. Gradual changes may indicate slow adjustments.

The controller 140 may adjust compression parameters based on detected posture. When the user is lying down, the controller 140 may reduce compression intensity or pause compression cycles. Gravitational effects on venous pooling may be minimal in the supine position. When the user transitions to sitting or standing, the controller 140 may increase compression intensity. The controller 140 may initiate an immediate compression cycle upon detecting the transition. This rapid response may counteract orthostatic blood pooling. The controller 140 may apply higher pressures during the first one to two minutes after standing. The controller 140 may then reduce pressures to a maintenance level.

When the user is standing for an extended period, the controller 140 may increase compression intensity to increase the blood flow. For example, if standing is detected for more than 5 minutes to 10 minutes continuously, the controller 140 may increase the compression force. More intense compression may combat progressive venous pooling during prolonged standing. When the user is walking, the controller 140 may detect periodic acceleration patterns. The controller 140 may reduce compression intensity or pause compression during active ambulation. Natural muscle contractions during walking may provide adequate venous return. Compression may resume when the user returns to stationary standing or sitting.

The device 200 may include cooling devices 250a and 250b for contracting veinous regions to increase local blood flow. The cooling devices may be positioned at specific anatomical locations. In some embodiments a first cooling device 250a may be positioned on the upper thigh region and a second cooling device 250b may be positioned on the lower leg region, however in other embodiments any suitable number of and placement of cooling devices can be used. In some embodiments the cooling devices may be placed over areas where superficial veins are prominent, placed on the popliteal region behind the knee and or placed on the medial thigh where the great saphenous vein runs.

The cooling devices 250a, 250b may employ various technologies for heat removal. In some embodiments thermoelectric cooling modules may be used, for example, Peltier devices may create a temperature differential when electric current is applied. The cold side of the Peltier device may be placed in contact with the skin and the hot side may be coupled to a heat sink. In further embodiments phase-change materials (PCM) may be employed. In one example a material with a melting point of 20 degrees Celsius to 25 degrees Celsius may be encapsulated in a pouch. The pouch may be cooled in a refrigerator before use. As the material melts, it may absorb heat from the skin.

In further embodiments circulating coolant systems may be used. In some embodiments the air that is used to pressurize the chambers is first cooled then send to the chamber which inflates the chamber and simultaneously cools the limb. In further embodiments a pump may circulate cooled liquid through channels in the device.

The cooling devices 250a, 250b may be controlled by the controller 140. Temperature sensors may monitor skin temperature at the cooling zones. The controller 140 may activate cooling when skin temperature exceeds a threshold. The controller 140 may modulate cooling power to maintain a target skin temperature. If skin temperature approaches this limit, the controller 140 may reduce or deactivate cooling.

The cooling devices may provide localized vasoconstriction of superficial veins and/or may cause the smooth muscle in vein walls to contract. As a result the vein diameter may decrease which may decrease venous capacitance. Blood may be displaced from superficial veins to deeper veins that may have more competent valves enhancing venous return. The cooling effect may be particularly beneficial in warm environments. Elevated ambient temperature may cause peripheral vasodilation which may increase venous pooling. The localized cooling provided by device 200 may counteract this effect.

The controller 140 may coordinate cooling activation with compression cycles. Cooling may be activated during compression to enhance the effect. Cooling may be activated between compression cycles to maintain venous constriction. The controller 140 may selectively activate individual cooling zones and may activate based on sensed skin temperature.

The device 200 may include a wireless communication subsystem. The communication subsystem may enable data transmission to internal and/or to external devices. In some embodiments, a Bluetooth Low Energy technology may be employed. The communication subsystem may transmit physiological data to a mobile application. Heart rate data may be transmitted in real-time to synchronize the compression cycles. Blood pressure measurements, posture and activity data, compression parameters or other suitable data may be transmitted. In some embodiments the controller and/or the mobile application may display this data to the user.

The controller and/or mobile application may provide a user interface for device control. For example, the user may adjust compression intensity or may select different compression modes. The different compression modes may include a standard mode that may provide regular sequential compression, a cardiac-synchronized mode may synchronize compression with heartbeat, a posture-adaptive mode that may automatically adjust based on detected posture, a cooling-assisted mode that may activate cooling, etc.

The mobile application may allow the user to log symptoms. The user may rate symptom severity on a numerical scale. Dizziness may be rated from 0 to 10. Fatigue may be rated from 0 to 10. The system may record the time of symptom occurrence. The application may correlate symptom data with physiological data, compression parameters, etc. Patterns may be identified, via algorithms that may include machine learning. The application may provide feedback to the user and/or the physician. The application may suggest adjustments to therapy settings.

The controller and/or mobile application may communicate with a cloud-based server. Data may be uploaded to the server for storage and analysis. Healthcare providers may access patient data through a secure web portal. Providers may review therapy adherence, may examine physiological trends, may identify concerning patterns, may send messages to patients through the application and/or may adjust therapy protocols remotely. Updated parameters may be downloaded to the device 200.

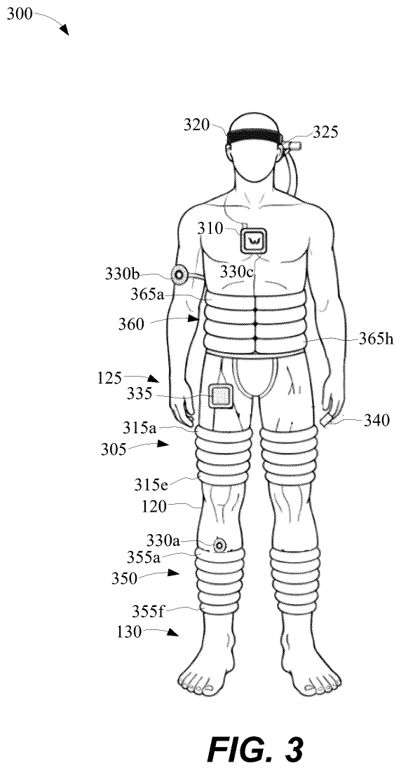

FIG. 3 illustrates an embodiment of a wearable compression device 300, according to embodiments of the disclosure. Compression device 300 may be or may include any of the components, features, or characteristics of any of the compression devices previously described, and any features of compression device 300 may be included in compression devices as previously discussed. As shown in FIG. 3, the device 300 may be similar to compression device 100, however compression device 300 may include an abdominal compression region 360, and the device may include additional sensors and/or components.

As shown in FIG. 3, the device 300 may include an upper sleeve 305 with a plurality of flexible air chambers 315. The chambers 315 may be arranged sequentially from an upper chamber 315a near the upper thigh region to a lower chamber 315e near the knee of the limb 130. The device 300 may integrate multiple types of physiological sensors and/or device. The device 300 may optionally include a lower sleeve 350 with a plurality of flexible air chambers 355. The chambers 355 may be arranged sequentially from an upper chamber 355a near the knee to a lower chamber 355f near the ankle of the limb 130.

The device 300 may also include an abdominal compression region 360 with a plurality of flexible air chambers 365. The chambers 365 may be arranged sequentially from an upper right chamber 365a near the right rib region to a lower left chamber 365h near the waist. In this particular embodiment there are two rows of flexible air chambers 365, however in other embodiments there may be one air chamber, one row of air chambers, or three or more rows of air chambers. Similar to the previous embodiments the flexible air chambers 365 may be configured to sequentially inflate/deflate, simultaneously inflate/deflate and/or inflate/deflate synchronization with a pulse rate of the user. Although FIG. 3 illustrates the abdominal compression region 360 as having eight chambers, any suitable number of chambers can be used between one and twenty.

A heart rate sensor 310 may be positioned on the chest region. The heart rate sensor 310 may employ electrocardiogram technology. Electrodes may be integrated into the sensor, into a chest strap or adhesive patch. The electrodes may detect electrical potentials on the skin surface. A differential amplifier may amplify the electrocardiogram signal. R-wave detection may be performed and heart rate variability metrics may be calculated from R-R interval time series.

A NIRS (Near-Infrared Spectroscopy)blood flow sensor 320 may be positioned on the head. The blood flow sensor 320 may comprise a near-infrared spectroscopy system. Light-emitting diodes may emit light at wavelengths of 760 nanometers and 850 nanometers which may correspond to absorption peaks of deoxygenated and oxygenated hemoglobin. Photodetectors may be positioned at multiple distances from the light source and may measure backscattered light that has traveled through tissue. The blood flow sensor 320 may calculate tissue oxygen saturation based on the modified Beer-Lambert law and may provide information about cerebral blood flow and oxygenation.

A transcranial Doppler sensor (TDS) 325 may be positioned on the head. The TDS sensor 325 may employ ultrasound technology. An ultrasound transducer may emit continuous or pulsed ultrasound waves that may be directed toward the middle cerebral artery through the temporal bone window. Moving blood cells may reflect the ultrasound waves with a frequency shift. The Doppler shift may be proportional to blood flow velocity. The sensor may measure cerebral blood flow velocity in real-time. Changes in cerebral perfusion may be detected.

One or more position sensors 330a, 330b, and 330c may be distributed across the body. A first position sensor 330a may be positioned on the lower leg. A second position sensor 330b may be positioned on the upper arm. A third position sensor 330c may be positioned on the chest. Each sensor may comprise an inertial measurement unit with accelerometer and/or gyroscope. The multiple sensor locations may allow for detailed assessment of body orientation and movement. Trunk orientation may be determined from the chest sensor 330c. Limb orientations may be determined from the arm sensor 330b and leg sensor 330a. Joint angles may be calculated from the relative orientations of adjacent body segments.

One or more cooling devices 335 may be integrated into the sleeve 305 and/or positioned on the limb 120. The one or more cooling devices 335 may be positioned over a region with prominent superficial veins. The device may employ any of the cooling technologies previously described. The cooling device may be controlled based on data from multiple sensors. Temperature sensors may monitor local skin temperature. Blood flow sensors may assess venous pooling. The controller may activate cooling when venous pooling is detected. The controller may modulate cooling intensity based on skin temperature feedback.

A pulse oximeter sensor 340 may be positioned on a finger. The sensor may measure arterial oxygen saturation. The sensor may provide SpO2 values ranging from less than 70 percent to 100 percent. The pulse oximeter sensor 340 may also provide a plethysmographic waveform. The waveform may be analyzed to assess peripheral perfusion.

The device 300 may implement a comprehensive monitoring approach. Data from all sensors may be collected continuously. The data may be synchronized with a common time reference. Timestamps may enable correlation of events across different data streams. The controller may analyze the integrated data to assess the user's physiological state. Heart rate, blood pressure, cerebral blood flow, tissue oxygenation, peripheral perfusion, and body position may all be considered together.

The controller may implement a closed-loop control system. The controller may adjust compression parameters based on the integrated sensor data. If cerebral blood flow decreases, the controller may increase compression intensity to boost venous return and cardiac output. If peripheral perfusion is poor, the controller may activate cooling to redistribute blood flow. If the user is experiencing tachycardia, the controller may synchronize compression with the cardiac cycle to reduce heart rate. The controller may continuously optimize therapy to maintain physiological parameters within target ranges.

The device 300 may employ machine learning algorithms for personalized therapy. The algorithms may analyze historical data from the user. Patterns may be identified that correlate compression parameters with physiological outcomes. The algorithms may learn which compression pressures, timing sequences, and cooling settings produce the best results for the individual user. The algorithms may predict optimal parameters for different situations. When the user is standing, a specific compression profile may be predicted to be most effective. When the user is sitting, a different profile may be predicted. The algorithms may continuously refine predictions as more data is accumulated.

The machine learning algorithms may be trained using supervised learning techniques. Labeled training data may be generated from user feedback. The user may rate symptom severity after each therapy session. Sessions with low symptom scores may be labeled as successful. Sessions with high symptom scores may be labeled as suboptimal. Features may be extracted from the physiological and compression data. Mean heart rate, blood pressure variability, compression pressure levels, and cooling activation frequency may serve as features. A regression model may be trained to predict symptom scores based on these features. The model may identify which parameter combinations are associated with the best outcomes.

Reinforcement learning techniques may also be employed. The controller may be configured as an agent that takes actions by adjusting compression parameters. The environment may be the user's physiological state. The agent may receive rewards based on achieving target physiological values. Maintaining heart rate within a normal range may provide a positive reward. Maintaining blood pressure within a normal range may provide a positive reward. User-reported symptom improvement may provide a positive reward. The agent may learn a policy that maximizes cumulative reward over time. The policy may specify which compression parameters to apply in each physiological state.

The machine learning models may be updated periodically. New data may be collected during each therapy session. The data may be uploaded to a cloud server. The models may be retrained on the cloud server using the accumulated data. Updated models may be downloaded to the device 300. The models may improve over time as more data becomes available. The therapy may become increasingly personalized and effective.

The device 300 may provide alerts based on sensor data. If heart rate exceeds a threshold, an alert may be generated. For example, the threshold may be 120 beats per minute for standing or 100 beats per minute for sitting. If blood pressure falls below a threshold, an alert may be generated. The threshold may be 90 millimeters of mercury systolic or 60 millimeters of mercury diastolic. If cerebral blood flow velocity decreases significantly, an alert may be generated. A decrease of more than 20 percent from baseline may trigger an alert. Alerts may be displayed on the mobile application. Alerts may be sent to healthcare providers. Alerts may prompt the user to sit down or take other actions.

The device 300 may log all sensor data and compression events. Data may be stored in non-volatile memory on the device. Data may be transmitted to the mobile application and cloud server. Comprehensive logs may enable detailed analysis of therapy effectiveness. Trends over days, weeks, or months may be examined. Seasonal variations may be identified. Medication changes may be correlated with physiological changes. The logs may support clinical decision-making and research.

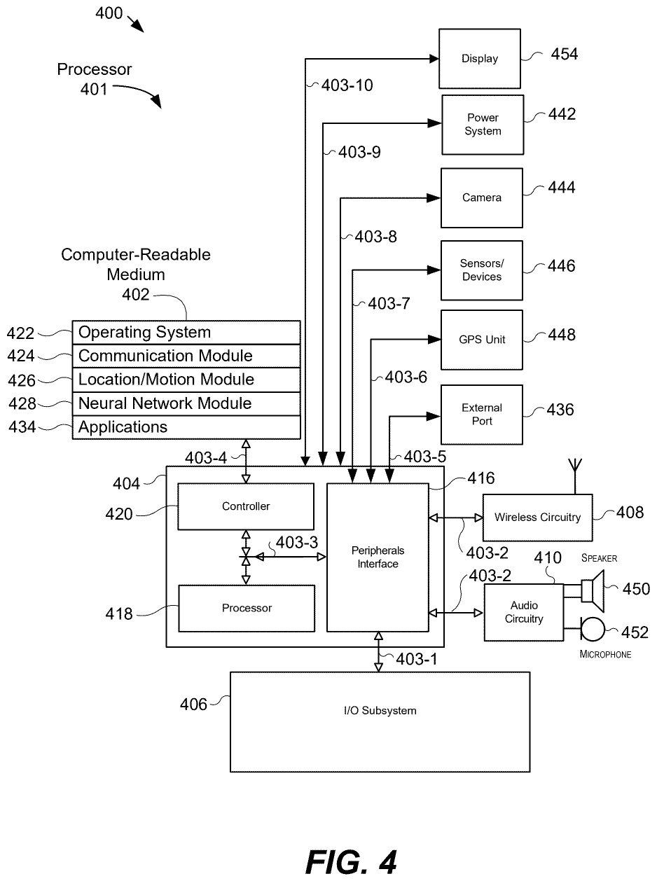

FIG. 4 illustrates a block diagram of a computing system 400 that may be used to operate any of the wearable compression devices described in this disclosure. Computing system 400 may be integrated within a separate controller, within the garment, located separately or one or more portions of the computing system may be distributed among the controller, the garment and one or more separate computing devices. As shown in FIG. 4, the system 400 may include a processor 401. The processor 401 may be a microcontroller or embedded processor. The processor may include a computer-readable medium 402. The computer-readable medium may comprise memory for storing program instructions and data. The memory may include volatile memory such as random access memory. The memory may include non-volatile memory such as flash memory.

The processor 401 may include a processing system 404. The processing system 404 may coordinate operations between the processor core 418 and other system components. The components of the processor 401 may be coupled by one or more communication buses or signal lines 403. The communication buses 403 may enable data transfer between the processor core 418, the computer-readable medium 402, and peripheral devices.

The computer-readable medium 402 may store an operating system 422. The operating system may manage hardware resources and provide services for application programs. The operating system may be a real-time operating system. The operating system may enable concurrent execution of multiple tasks. The operating system may provide scheduling, memory management, and inter-process communication.

A communication module 424 may be stored in the computer-readable medium 402. The communication module may facilitate wireless communication with external devices. The module may implement Bluetooth Low Energy protocols. The module may handle pairing, connection management, and data transmission. The module may interface with wireless circuitry 408. The wireless circuitry may include a radio transceiver and antenna 416.

A location and motion module 426 may be stored in the computer-readable medium 402. The module may process data from position sensors. The module may implement sensor fusion algorithms. The module may calculate body orientation and posture. The module may detect postural transitions. The module may classify activities such as sitting, standing, or walking. The module may provide posture and activity data to other system components.

A neural network module 428 may be stored in the computer-readable medium 402. The module may implement machine learning algorithms. The module may include trained neural network models. The models may predict optimal compression parameters based on physiological state. The models may be updated with new training data. The module may perform inference in real-time to guide therapy adjustments.

Application programs 434 may be stored in the computer-readable medium 402. The applications may implement specific functions of the device. A compression control application may manage the sequential inflation and deflation of air chambers. A cardiac synchronization application may coordinate compression timing with heart rate. A thermal control application may regulate cooling device operation. A data logging application may record sensor data and events.

The processor 401 may include a controller 420 and a processor core 418. The controller 420 may manage communication between the processor core and peripheral devices. The processor core 418 may execute program instructions. The processor core may perform calculations and make control decisions.

A peripherals interface may connect the processor 401 to various input and output subsystems. An I/O subsystem 406 may provide interfaces for user input and output. The I/O subsystem may include buttons for power and mode selection. The I/O subsystem may include light-emitting diodes for status indication. The I/O subsystem may include a small display for showing basic information.

The processor 401 may include one or more contact intensity sensors for detecting intensity of contacts on a touch screen. The processor 401 may include one or more tactile output generators for generating tactile outputs for a user of the processor 401. The contact intensity sensors may measure the force or pressure applied during touch input. The tactile output generators may provide haptic feedback to the user.

The I/O subsystem 406 may include physical buttons for user input. A power button may turn the device on or off. The power button may be depressed and held in the depressed state for a predefined time interval to turn the power on or off. The power button may be depressed and released before the predefined time interval has elapsed to lock the device. The power button may be used to unlock the device or initiate an unlock process. Volume adjustment buttons may increase or decrease audio output levels. A menu button may be used to navigate to any application in a set of applications that may be executed on the processor 401. The menu button may be implemented as a physical button or as a soft key in a graphical user interface displayed on the display 454. The processor 401 may also accept verbal input for activation or deactivation of some functions through the microphone 452.

Audio circuitry 410 may be connected to the peripherals interface. The audio circuitry may drive a speaker 450. The speaker may provide audible alerts or feedback. The audio circuitry may receive input from a microphone 452. The microphone may enable voice commands or audio recording.

Wireless circuitry 408 may be connected to the peripherals interface. The wireless circuitry may implement Bluetooth Low Energy communication. The circuitry may include a radio transceiver operating in the 2.4 gigahertz band. An antenna 416 may be integrated into the device housing. The wireless circuitry may enable communication with a mobile application.

The external port 436 may be a USB connector, FireWire connector, Lightning connector, or 60-pin connector. The port may enable wired data transfer to other devices. The port may enable firmware updates to be installed on the processor 401. The port may provide power for charging the battery in the power system 442. The external port 436 may be adapted for coupling directly to other devices or indirectly over a network such as the Internet or a wireless local area network.

A display 454 may be connected to the peripherals interface. The display may be a small OLED or LCD screen. The display may show heart rate, battery level, or compression status. The display may have a resolution of 128 by 64 pixels or 140 by 140 pixels. The display may consume 5 milliwatts to 20 milliwatts of power.

The display 454 may display one or more graphics within a user interface. A user may be enabled to select one or more of the graphics by making a gesture on the graphics. The gesture may be made with one or more fingers or one or more styluses. Selection of one or more graphics may occur when the user breaks contact with the one or more graphics. The gesture may include one or more taps, one or more swipes from left to right, right to left, upward or downward. The gesture may include a rolling of a finger from right to left, left to right, upward or downward that has made contact with the display 454. A point of contact between the touch-sensitive display and the user may correspond to one or more digits of the user. The user may make contact with the touch-sensitive display using any suitable object or appendage such as a stylus, pen, or finger.

The display 454 may be a touch-sensitive display in some embodiments. The touch-sensitive display may accept input from the user based on haptic or tactile contact. The touch-sensitive display may form a touch-sensitive surface that accepts user input. The touch-sensitive display may detect contact and any movement or release of the contact on the touch-sensitive display. The detected contact may be converted into interaction with user-interface objects displayed on the touch screen when the contact occurs. The touch-sensitive display may detect contact using any suitable touch sensitivity technologies including capacitive, resistive, infrared, and surface acoustic wave technologies. The touch-sensitive display may also include other proximity sensor arrays or other elements for determining one or more points of contact with the touch-sensitive display.

A power system 442 may be connected to the peripherals interface. The power system may include a rechargeable battery. The battery may be a lithium-ion or lithium-polymer cell. The power system may include charging circuitry. A USB-C port or magnetic connector may be provided for charging. The power system may include voltage regulators. The regulators may provide stable voltages to electronic components.

A camera 444 may be connected to the peripherals interface. The camera may capture images or video. The camera may be used for documentation or telemedicine consultations. The camera may have a resolution of 2 megapixels to 8 megapixels.

Sensors and devices 446 may be connected to the peripherals interface. This category may include the various physiological sensors and devices (e.g., cooling devices, air valves, etc.) described previously. Heart rate sensors, blood pressure sensors, blood flow sensors, temperature sensors, and position sensors may all be included. The sensors may provide analog or digital outputs. Analog-to-digital converters may be used to digitize analog sensor signals. The digitized data may be processed by the processor 401.

The sensors and devices 446 may also include actuators. Air pumps for inflating chambers may be included. Valves for controlling airflow may be included. Cooling devices such as Peltier modules may be included. The processor 401 may send control signals to these actuators. Pulse-width modulation may be used to control pump speed or cooling power.

A GPS unit 448 may be connected to the peripherals interface. The GPS unit may receive signals from global positioning satellites. The unit may determine the device's geographic location. Location data may be used to correlate symptoms with environmental factors. Location data may be logged for activity tracking.

An external port 436 may be connected to the peripherals interface. The port may be a USB connector. The port may enable wired data transfer. The port may enable firmware updates. The port may provide power for charging the battery.

The computing system 400 may execute control algorithms for the compression device. The processor 401 may read sensor data from the sensors and devices 446. The processor may execute the compression control application. The application may determine target pressures for each air chamber. The application may send commands to the air pumps and valves. The pumps may inflate chambers to the target pressures. The valves may deflate chambers after the specified duration.

The processor 401 may execute the cardiac synchronization application. The application may receive heart rate data from the heart rate sensor. The application may detect R-waves in the electrocardiogram signal. The application may calculate the timing of diastole. The application may trigger chamber inflation to coincide with diastole. The synchronization may optimize venous return.

The processor 401 may execute the thermal control application. The application may receive temperature data from temperature sensors. The application may compare skin temperature to target values. If temperature exceeds the target, the application may activate cooling devices. The application may modulate cooling power using pulse-width modulation. The application may monitor temperature continuously to prevent excessive cooling.

The processor 401 may execute the neural network module 428. The module may receive current physiological data as input. Heart rate, blood pressure, posture, and activity level may be input to the neural network. The network may output predicted optimal compression parameters. The compression control application may use these parameters to adjust therapy. The neural network may enable adaptive, personalized therapy.

The processor 401 may execute the communication module 424. The module may transmit data to the mobile application via the wireless circuitry 408. Physiological data may be transmitted in real-time. Compression parameters may be transmitted. Battery status may be transmitted. The module may receive commands from the mobile application. The user may adjust settings through the application. The commands may be received and executed by the processor 401.

The computing system 400 may implement safety monitoring. The processor 401 may continuously check for abnormal conditions. If chamber pressure exceeds a maximum limit, the processor may immediately open exhaust valves .. If skin temperature falls below a minimum limit, the processor may deactivate cooling. The minimum limit may be 18 degrees Celsius. If heart rate exceeds a critical threshold, the processor may pause compression and generate an alert.

The computing system 400 may log data and events. The processor 401 may write data to non-volatile memory in the computer-readable medium 402. Sensor readings may be logged with timestamps. Compression events may be logged. User inputs may be logged. Alerts and errors may be logged. The logs may be retrieved for analysis. The logs may be transmitted to the cloud server for long-term storage.

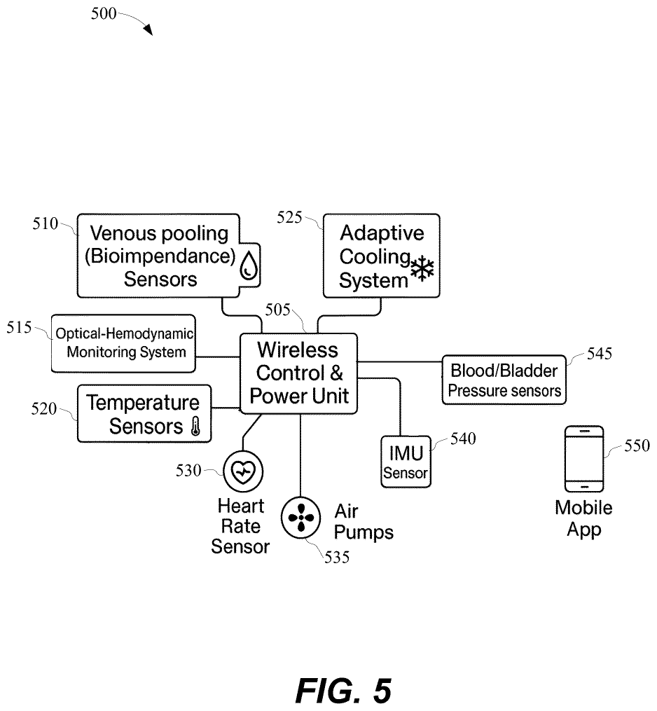

FIG. 5 illustrates a system architecture 500 showing the integration of multiple subsystems in any of the wearable compression devices described herein, and that may be employed with computing device 400 shown in FIG. 4. As shown in FIG. 5, a wireless control and power unit 505 may serve as the central hub. The unit 505 may house the processor, battery, and wireless communication circuitry. The unit 505 may be positioned at the waist of the garment, may be disposed within the controller, may be disposed within a separate electronic device or one or more components may be distributed within the garment, the controller, and/or within a separate electronic device.

Venous pooling bioimpedance sensors 510 may be connected to the wireless control and power unit 505. The sensors may measure electrical impedance of leg tissues. Impedance may be measured at multiple frequencies. Low-frequency impedance may reflect extracellular fluid volume. Changes in impedance may indicate venous blood pooling. The sensors may provide real-time feedback on venous status. The control unit may use this data to adjust compression.

An optical-hemodynamic monitoring system 515 may be connected to the control unit 505. The system may employ near-infrared spectroscopy, may measure tissue oxygen saturation and/or assess blood flow in muscles. The data may indicate the effectiveness of compression therapy. If tissue oxygenation decreases, compression may be increased to improve perfusion.

Temperature sensors 520 may be connected to the control unit 505. The sensors may monitor skin temperature at multiple locations. The sensors may provide feedback for thermal control. The control unit may activate cooling when temperature exceeds thresholds. The control unit may deactivate cooling when temperature falls below limits.

An adaptive cooling system 525 may be connected to the control unit 505. The system may include cooling devices positioned at strategic locations. The devices may employ Peltier modules, phase-change materials, or circulating coolant. The control unit may send commands to activate or deactivate individual cooling zones. The control unit may modulate cooling power based on temperature sensor feedback.

A heart rate sensor 530 may be connected to the control unit 505. The sensor may provide real-time cardiac rhythm data. The control unit may use this data for cardiac synchronization. The control unit may time compression cycles to coincide with diastole. The synchronization may enhance hemodynamic efficiency.

One or more air pumps and/or compressed air devices 535 may be connected to the control unit 505. The pumps and/or compressed air devices 535 may supply compressed air to the inflatable chambers. The control unit 505 may send commands to activate the pumps. The control unit 505 may regulate pump speed to control inflation rate. The pumps may be powered by the battery in the control unit.

An inertial measurement unit sensor 540 may be connected to the control unit 505. The sensor may include accelerometers and gyroscopes. The sensor may detect body orientation and movement which may be used to determine posture. The control unit may adjust compression based on whether the user is lying, sitting, or standing.

Blood pressure sensors 545 may be connected to the control unit 505. The sensors may measure blood pressure periodically or continuously. Oscillometric measurements may be performed using the compression chambers as a blood pressure cuff. Continuous estimation may be performed using pulse transit time. The control unit may use blood pressure data to assess therapy effectiveness and adjust parameters.

A mobile application and/or device 550 may communicate with the control unit 505. The application may run on a smartphone or tablet. The application may connect via Bluetooth Low Energy. The application may display real-time physiological data. The application may allow the user to adjust settings. The application may log symptom data. The application may upload data to a cloud server.

The system architecture may enable comprehensive monitoring and control. Data from all sensors may be integrated. The control unit may analyze the data holistically. Compression, cooling, and other interventions may be coordinated. The system may adapt to the user's changing physiological state. The system may provide personalized therapy that evolves over time.

The wireless control and power unit may implement power management. The unit may monitor battery state of charge. The unit may provide low-battery warnings. The unit may enter low-power modes when not actively delivering therapy. The unit may disable non-essential functions to conserve power. The unit may provide an estimated remaining battery life to the user.

The wireless control and power unit may implement firmware updates. New firmware versions may be downloaded from the cloud server. The mobile application may transfer the firmware to the control unit via Bluetooth. The control unit may install the update and reboot. Firmware updates may add new features or improve performance. Updates may fix bugs or enhance safety.

The system may implement data security and privacy measures. Data transmitted wirelessly may be encrypted. Advanced Encryption Standard with 128-bit or 256-bit keys may be used. Authentication may be required before data can be accessed. The mobile application may require a password or biometric authentication. Data stored on the cloud server may be encrypted at rest. Access controls may limit who can view patient data. Audit logs may track all data access.

The system may be used in various clinical and non-clinical applications. Patients with postural orthostatic tachycardia syndrome may use the device to manage orthostatic intolerance. The device may reduce symptoms such as dizziness and fatigue. Patients with neurogenic orthostatic hypotension may use the device to prevent blood pressure drops upon standing. Patients with chronic venous insufficiency may use the device to reduce leg swelling and discomfort. Athletes may use the device to enhance recovery after training. The device may accelerate removal of metabolic waste products. Travelers may use the device during long flights to prevent deep vein thrombosis. The device may maintain circulation during prolonged sitting.

The device may be integrated into a broader healthcare ecosystem. Data from the device may be incorporated into electronic health records. Healthcare providers may review device data during clinical appointments. Trends in physiological parameters may inform treatment decisions. Medication adjustments may be made based on device data. The device may enable remote patient monitoring. Providers may identify problems early and intervene before conditions worsen. The device may reduce the need for in-person visits. Telemedicine consultations may be supported by device data.

The device may support clinical research. Anonymized data from multiple users may be aggregated. Population-level trends may be analyzed. Researchers may identify factors associated with treatment success. New compression protocols may be developed and tested. The device may enable large-scale studies that would be impractical with traditional methods. The device may accelerate the development of evidence-based guidelines for compression therapy.

The device may be customized for specific patient populations. Pediatric versions may be developed with smaller sizes and age-appropriate features. Geriatric versions may include simplified controls and larger displays. Versions for athletes may emphasize performance enhancement and recovery. Versions for occupational use may be designed for durability and extended wear. The modular architecture may allow for easy customization without redesigning the entire system.

The device may incorporate additional sensors. Electrodermal activity sensors may measure skin conductance to assess autonomic nervous system function. Respiration sensors may monitor breathing rate and depth. Core temperature sensors may track body temperature. Hydration sensors may assess fluid status. The additional data may enable even more comprehensive monitoring and personalized therapy.

The device may incorporate advanced materials. Smart textiles with embedded sensors and actuators may be developed. Conductive fibers may eliminate the need for separate wiring. Shape-memory alloys may enable chambers that change shape in response to temperature. Graphene-based sensors may provide enhanced sensitivity and durability. Biodegradable materials may reduce environmental impact.

The device may incorporate artificial intelligence in future versions. Deep learning models may be trained on large datasets. The models may identify complex patterns that are not apparent to human observers. The models may predict symptom exacerbations hours or days in advance. Preventive interventions may be initiated before symptoms occur. Natural language processing may enable voice-controlled operation. The user may give verbal commands to adjust settings or report symptoms.

The device may be part of a connected health platform. Multiple devices may communicate with each other. A smartwatch may provide additional heart rate and activity data. A smart scale may provide weight data. A continuous glucose monitor may provide metabolic data. The platform may integrate data from all sources. A comprehensive health profile may be created. The compression device may adjust therapy based on the integrated data.

### Methods of Use

A method for enhancing venous return in a user may be provided. The method may comprise providing a wearable compression garment system as described herein. The method may comprise positioning the garment on the user's lower extremities. The positioning may ensure that inflatable air chambers are in contact with the user's legs. The method may comprise activating a control unit. The activation may initiate a sequential compression cycle. The sequential compression cycle may comprise inflating a first chamber located at a distal region. The distal region may be at the ankle. The first chamber may be inflated to a target pressure. The target pressure may range from 10 to 200 millimeters of mercury. The sequential compression cycle may comprise sequentially inflating subsequent chambers in a proximal direction. The proximal direction may be toward the thigh. The sequential compression cycle may comprise maintaining inflation for a hold period. The hold period may range from one to three seconds. The sequential compression cycle may comprise sequentially deflating the chambers. The method may comprise repeating the compression cycle at a predetermined frequency. The predetermined frequency may create a continuous wave of pressure. The continuous wave of pressure may propel venous blood upward toward the heart.

The method may further comprise detecting the user's heartbeat in real time. The detection may use a heart rate monitor. The method may comprise calculating timing of diastole within each cardiac cycle. The method may comprise synchronizing initiation of the compression cycle such that peak compression in proximal chambers occurs during diastole. The synchronization may maximize venous return efficiency. The synchronization may reduce cardiac workload.

The method may further comprise continuously monitoring the user's posture. The monitoring may use inertial measurement unit sensors. The method may comprise detecting a change in posture. The change may be a transition from sitting to standing. The method may comprise automatically adjusting compression parameters based on the detected posture. The adjustment may provide posture-appropriate circulatory support. In a lying posture, compression may be disabled or set to minimal levels. In a sitting posture, moderate compression may be applied, focused on lower leg chambers. In a standing posture, full sequential compression may be applied from ankle to thigh at higher pressure. In a walking or running posture, compression may be synchronized with a gait cycle detected by accelerometer data.

The method may further comprise activating a thermal regulation subsystem. The activation may apply localized cooling to anatomical regions with superficial veins. The method may comprise monitoring skin temperature in the regions using temperature sensors. The method may comprise modulating cooling power to achieve a target skin temperature reduction. The target reduction may be five to ten degrees Celsius below baseline. The modulation may induce vasoconstriction of superficial veins. The vasoconstriction may enhance venous return.

The method may further comprise continuously acquiring physiological data from multiple sensors. The sensors may include heart rate monitors. The sensors may include blood pressure sensors. The sensors may include blood flow sensors. The sensors may include bioimpedance sensors. The method may comprise calculating derived parameters indicative of circulatory status. The derived parameters may include a venous pooling index. The derived parameters may include tissue oxygenation. The method may comprise comparing the parameters to target values. The method may comprise automatically adjusting compression and cooling parameters in real time to minimize deviations from target values. The adjustment may implement a closed-loop control system. The closed-loop control system may optimize circulatory support.

The method may further comprise logging sensor data, therapy parameters, and patient-reported symptoms over multiple therapy sessions. The method may comprise analyzing the logged data using a machine learning algorithm. The analysis may identify optimal therapy parameters for the individual user. The method may comprise generating a personalized compression protocol based on the analysis. The method may comprise implementing the personalized protocol in the control unit. The protocol may be periodically updated as additional data is accumulated. The updates may enable continuous therapy refinement. The updates may enable continuous therapy optimization.

The method may further comprise transmitting physiological data and therapy logs from the garment to a cloud server. The transmission may occur via a mobile application. The method may comprise providing access to the data to an authorized healthcare provider via a clinician web portal. The method may comprise reviewing the data by the healthcare provider to assess therapy efficacy and patient adherence. The method may comprise remotely adjusting therapy parameters via the clinician web portal. The method may comprise pushing updated parameters from the cloud server to the garment's control unit. The pushing may enable remote personalization of treatment. The pushing may enable remote optimization of treatment.

A method for treating Postural Orthostatic Tachycardia Syndrome in a patient may be provided. The method may comprise providing a wearable compression garment system as described herein. The method may comprise instructing the patient to wear the garment during upright activities for a therapeutically effective duration. The duration may be four to six hours daily or up to 24 hours daily. The method may comprise activating sequential compression synchronized with the patient's heartbeat. The activation may enhance venous return. The activation may reduce compensatory tachycardia. The method may comprise monitoring the patient's heart rate and symptoms over time. The monitoring may show a clinically significant reduction in orthostatic heart rate increase. The monitoring may show improvement in symptom severity.

A method for treating Neurogenic Orthostatic Hypotension in a patient may be provided. The method may comprise providing a wearable compression garment system as described herein. The method may comprise activating posture-adaptive compression. The posture-adaptive compression may automatically increase compression intensity upon detection of sit-to-stand or supine-to-stand transitions. The method may comprise monitoring the patient's blood pressure during the transitions. The monitoring may show a reduction in orthostatic blood pressure drop. The reduction may prevent symptoms such as dizziness and syncope.

A method for enhancing athletic recovery may be provided. The method may comprise providing a wearable compression garment system as described herein to an athlete following intense physical exercise. The method may comprise activating a recovery mode. The recovery mode may comprise gentle sequential compression. The recovery mode may comprise optional localized cooling. The method may comprise wearing the garment for a recovery period. The recovery period may be thirty to sixty minutes while resting. The wearing may promote venous return. The wearing may reduce muscle swelling and inflammation. The wearing may accelerate recovery from exercise-induced fatigue.

A method for maintaining circulatory stability in high-G environments may be provided. The method may comprise providing a wearable compression garment system as described herein to a pilot or astronaut. The method may comprise activating high-intensity sequential compression upon detection of high-G acceleration. The detection may occur using inertial measurement unit sensors. The method may comprise synchronizing compression with the user's heartbeat. The synchronization may maximize venous return. The synchronization may maintain cerebral perfusion. The maintenance may reduce risk of G-induced loss of consciousness. The maintenance may improve G-tolerance.

For simplicity, various internal components, such as the control circuitry, graphics circuitry, bus, memory, storage device and other components of electronic device 100 (see FIG. 1) are not shown in the figures.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that substantial variations may be made in accordance with specific implementations. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The terms “machine-readable medium” and “computer-readable medium” as used herein refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media, punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, compact disc read-only memory (CD-ROM) or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

1. A device arranged to be worn on a human body, the device comprising:
a first chamber arranged to at least partially encircle a portion of the human body;
a second chamber arranged to at least partially encircle the portion of the human body and arranged to be positioned at a location above the first chamber on the portion of the human body; and
a controller configured to at least partially inflate the first and the second chambers.

2. The device of claim 1, wherein the controller is further configured to sequentially inflate the first chamber before the second chamber.

3. The device of claim 2, wherein the controller is further configured to sequentially deflate the first chamber before the second chamber.

4. The device of claim 2, wherein the controller is further configured to perform the sequential inflation in rhythm with a pulse of the human.

5. The device of claim 1, wherein the controller is further configured to inflate the first chamber to a first pressure and inflate the second chamber to a second pressure, wherein the second pressure is less than the first pressure.

6. The device of claim 1, wherein the controller is further configured to detect a recumbent position of the human and in response, at least partially deflate the first and the second chambers.

7. The device of claim 1, wherein the portion of the human body is a leg.

8. The device of claim 1, wherein the portion of the human body is an abdomen.

9. The device of claim 1, wherein the controller is further configured to modulate the at least partial inflation of the first and the second chambers based on a circumference of the leg.

10. The device of claim 1, wherein the controller is further configured to detect a blood pressure of the human and in response, modulate the at least partial inflation of the first and the second chambers.

11. A device arranged to at least partially receive a human limb, the device comprising:
a sleeve having a length extending between a first end and a second end and arranged to receive a portion of the limb such that the first end is proximate a base of the limb and the second end is proximate a distal end of the limb, the sleeve including:
a plurality of flexible air chambers disposed along at least a portion of the length of the sleeve, wherein each of the plurality of air chambers are arranged to be individually inflated and deflated; and
a controller arranged to at least partially inflate each of the plurality of air chambers.

12. The device of claim 11, wherein the controller is arranged to inflate a first chamber of the plurality of chambers to a first pressure and to inflate a second chamber of the plurality of chambers to a second pressure, wherein the first pressure is greater than the second pressure.

13. The device of claim 12, wherein the controller is arranged to simultaneously inflate the first chamber and the second chamber.

14. The device of claim 12, wherein the controller is arranged to sequentially inflate the first chamber then the second chamber.

15. The device of claim 14, wherein the controller is further configured to perform the sequential inflation in rhythm with a pulse of the human.

16. The device of claim 11, wherein the controller is configured to detect a recumbent position of the human and in response, at least partially deflate at least one of the plurality of air chambers.

17. A method of operating a device, the method comprising:
disposing a sleeve at least partially around a portion of a human, wherein the sleeve includes a plurality of flexible air chambers disposed along at least a portion of a length of the sleeve and wherein each of the plurality of air chambers are arranged to be individually inflated and deflated; and
at least partially inflating the plurality of air chambers.

18. The method of claim 17, wherein the plurality of air chambers are simultaneously at least partially inflated.

19. The method of claim 17, wherein the plurality of air chambers are sequentially at least partially inflated.

20. The method of claim 17, wherein the controller is further configured to perform the sequential inflation and the sequential deflation in rhythm with a pulse detected in the human.
